(19) United States
(12) Patent Application Publication
(10) Pub. No.: US 2011/0243526 A1
(43) Pub. Date: Oct. 6, 2011

(54) Video/Audio Player

(75) Inventors: Kazushige HIROI, Machida (JP); Takanori Eda, Yokohama (JP); Kenji Katsumata, Yokohama (JP)

(73) Assignee: Hitachi Consumer Electronics Co., Ltd., Tokyo (JP)

(21) Appl. No.: 12/979,041

(22) Filed: Dec. 27, 2010

(30) Foreign Application Priority Data
Mar. 30, 2010 (JP) 2010-077126

(51) Int. Cl. H04N 9/80

(52) U.S. Cl. 386/241; 386/E05.003

(57) ABSTRACT

A video/audio player includes a video/audio data input section that inputs video/audio data, a playback control section that controls playback of the input video/audio data, a chapter point setting section that detects an end point of a given interval of the input video/audio data, and sets a chapter point to the detected end point, and an automatic skip interval setting section that detects the given interval of the input video/audio data as an interval to be automatically skipped. The playback control section automatically skips the given interval set by the automatic skip interval setting section at the time of reproducing the input video/audio data, and upon receiving a skip instruction from a user, skips a reproducing playback position to a chapter point temporally after and closest to the reproducing playback position among the chapter points set by the chapter point setting points.

### CLAIM OF PRIORITY

The present application claims priority from Japanese patent application JP 2010-077126 filed on Mar. 30, 2010, the content of which is hereby incorporated by reference into this application.

### FIELD OF THE INVENTION

The present invention relates to a video/audio player that can playback video/audio data, and more particularly to a video/audio player that can effectively skip portions of no interest to a user, such as commercial message (CM) scenes in a video.

### BACKGROUND OF THE INVENTION

Viewable movie data consisting of video/audio data such as digital terrestrial broadcasting, BS, CS, or internet videos has been increased. In addition, with an increase in the capacity of an HDD and the evolution of a video compression technology, the volume of video/audio data that can be held in equipment possessed by the user is increased. However, no matter how large the viewable video/audio data volume is, the user's viewable time per se is not changed, and limited. This makes it necessary to efficiently view the video/audio data. In particular, there is much demand to skip portions of no interest to the user, such as CM scenes in video/audio data, and efficiently view the video/audio data.

In order to satisfy such demand, there is a need to detect the portion such as CM scenes from the video/audio data. As a method of detecting CM intervals, for example, JP-A-2007-49515 discloses a method and device for detecting the CM intervals on the basis of a silence interval and a scene change interval in the video/audio data. JP-A-2007-13359 discloses a method and device for detecting CM intervals by detecting changes in a video and audio mode in the video/audio data. JP-A-Hei8(1996)-317342 discloses a method and device for detecting CM intervals with the use of only silence intervals in the video/audio data. JP-A-2006-270299 discloses a method and device for detecting CM intervals by evaluating caption nondisplay time scenes and predetermined time scenes with the use of caption information included in the video/audio data.

As a device for effectively viewing the video/audio data with the use of CM interval detection, for example, JP-A-2000-354225 and JP-A-2000-354223 disclose a device in which a chapter point is set to each end point of the CM intervals detected by the CM interval detecting method, and the CM intervals can be explicitly slip according to an instruction from the user. JP-T-Hei10(1998)-507884 discloses a device in which sets of a start point and an end point of each CM interval are indicated to automatically skip the CM intervals.

### SUMMARY OF THE INVENTION

However, in the related art, as it now stands, there is false detection or detection failure of the CM intervals. Accordingly, in the case where the CM intervals are automatically skipped, there arises such a problem that intervals which are not the CM intervals are actually skipped. Also, in the method in which the chapter point is, set to each endpoint of the CM intervals, and the CM intervals are skipped on the basis of skip operation by the user, the user must depress a skip button each time he conducts skip instructions.

The present invention has been made to solve the above problem, and therefore an object of the present invention is to provide an easy-to-use video/audio player that can slip a given interval under the existing circumstances where there is false detection or detection failure of the given interval to be skipped according to the user's intention.

A typical aspect of the present invention disclosed in the present application will be described below. That is, the video/audio player includes a video/audio data input unit that inputs video/audio data, a playback control unit that controls playback of the input video/audio data, a chapter point setting unit that detects an endpoint of a given interval of the input video/audio data and sets a chapter point to the detected end point, and an automatic skip interval setting unit that detects the given interval of the input video/audio data as an interval to be automatically skipped, wherein the playback control unit automatically skips the given interval set by the automatic skip interval setting unit during playback of the input video/audio data, and skips to a chapter point temporally after and closest to a reproducing playback position among the chapter points set by the chapter point setting points according to a skip instruction from a user.

According to the typical aspect of the present invention, even if there is detection failure or false detection of the given interval to be skipped according to the user's intention, the given interval can be automatically skipped to the utmost extent, and the given interval can be surely skipped by simple operation. As a result, the video/audio data can be efficiently viewed.

### BRIEF DESCRIPTION OF THE DRAWINGS

FIG. 1 is a diagram illustrating a hardware configuration of a video/audio player according to a first embodiment of the present invention;

FIG. 2 is a functional block diagram illustrating the video/audio player according to the first embodiment of the present invention, which is a diagram illustrating a software configuration of a central processing unit according to the first embodiment of the present invention;

FIG. 3 is an explanatory diagram for describing the outline of a method of detecting CM intervals according to only audio in video/audio data according to the present invention;

FIG. 4 is a flowchart showing an example of the CM interval detecting method when the CM intervals are detected according to only the audio in the video/audio data according to the present invention;

FIG. 5 is a diagram illustrating an example of the CM intervals when the CM intervals are detected according to only the audio in the video/audio data according to the present invention;

FIG. 6 is an explanatory diagram for describing a chapter point setting method in a chapter point setting unit according to an embodiment of the present invention;

FIG. 7 is an explanatory diagram for describing the outline of a method of detecting the CM intervals according to video and audio in the video/audio data according to the present invention;

FIG. 8 is a flowchart showing an example of the CM interval detecting method when the CM intervals are detected according to the video and the audio in the video/audio data according to the present invention;

FIG. 9 is a diagram illustrating an example of the CM intervals when the CM intervals are detected according to the video and the audio in the video/audio data according to the present invention;

FIG. 10 is an explanatory diagram for describing an automatic skip interval setting method in an automatic skip interval setting unit according to an embodiment of the present invention;

FIG. 11 is a diagram showing an example of a data structure of chapter data according to the embodiment of the present invention;

FIG. 12 is a diagram showing an example of a data structure of automatic skip interval data according to the embodiment of the present invention;

FIG. 13 is a flowchart showing an example of processing contents of a playback control unit according to the embodiment of the present invention;

FIG. 14 is a diagram illustrating an example of a display screen configuration of the video/audio player according to the embodiment of the present invention;

FIG. 15 is a diagram illustrating a display example of a running bar displayed in a running bar display area in the display screen configuration of the video/audio player according to the embodiment of the present invention;

FIG. 16 is an explanatory diagram for describing a user interface of the video/audio player according to the embodiment of the present invention;

FIG. 17 is a diagram illustrating a display example of a menu of the video/audio player according to the embodiment of the present invention, which is particularly a diagram illustrating a display screen example when validity/invalidity of chapters and validity/invalidity of automatic skip can be set;

FIG. 18 is a diagram illustrating an example of a back position when a “back” button of automatic skip is depressed by a user in the video/audio player according to the embodiment of the present invention;

FIG. 19 is a functional block diagram illustrating a video/audio player according to a second embodiment of the present invention, which is particularly a diagram illustrating a software configuration of a central processing unit according to a second embodiment of the present invention;

FIG. 20 is an explanatory diagram illustrating an example of a CM interval detecting method in a chapter point/automatic skip interval setting unit of the video/audio player according to the second embodiment of the present invention, which is particularly an explanatory diagram illustrating an example of a parameter setting method for detecting the CM intervals in order to set the chapter points in a method of detecting the CM intervals by using only the audio data;

FIG. 21 is an explanatory diagram illustrating an example of a CM interval detecting method in a chapter point/automatic skip interval setting unit of the video/audio player according to the second embodiment of the present invention, which is particularly an explanatory diagram illustrating an example of a parameter setting method for detecting the CM interval in order to set the automatic skip interval in a method of detecting the CM interval by using only the audio data; and

FIG. 22 is an explanatory diagram illustrating an example of a CM interval detecting method in a chapter point/automatic skip interval setting unit of the video/audio player according to the second embodiment of the present invention, which is particularly an explanatory diagram illustrating another example of a parameter setting method for detecting the CM intervals for automatically setting the skip intervals in a method of detecting the CM intervals by using only the audio data.

### DETAILED DESCRIPTION OF THE PREFERRED EMBODIMENTS

Hereinafter, the respective embodiments of the present invention will be described with reference to the accompanying drawings.

### First Embodiment

First, a hardware configuration of a video/audio player according to a first embodiment of the present invention will be described.

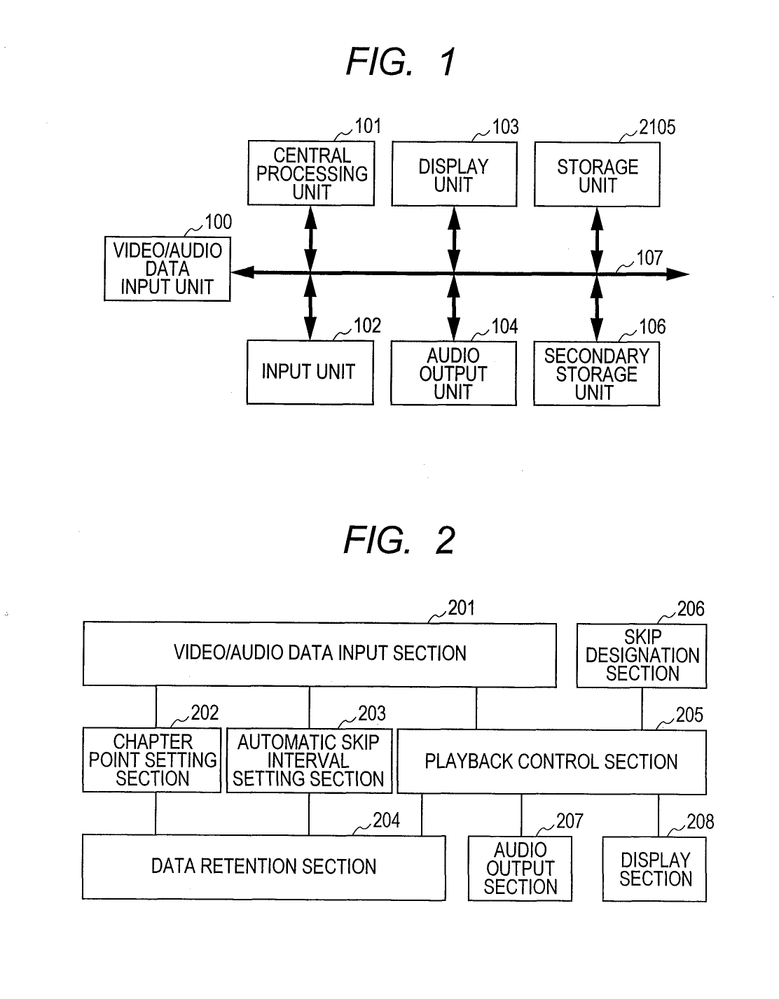

FIG. 1 illustrates an example of the hardware configuration of the video/audio player according to the first embodiment of the present invention. In this description, it is assumed that the video/audio player is mainly a PC (personal computer). However, the video/audio player is not limited to this configuration. That is, the video/audio player may be a recorder, a TV, or a cellular phone if the device can reproduce video/audio data.

As illustrated in FIG. 1, the video/audio player according to the first embodiment includes a video/audio data input unit 100, a central processing unit 101, an input unit 102, a display unit 103, an audio output unit 104, a storage unit 105, and a secondary storage unit 106. The respective units 100 to 106 are connected to each other through a bus 107, and data can be mutually transferred between the respective units.

The secondary storage unit 106 is not always required when the storage unit 105 satisfies the function of the secondary storage unit 106. The display unit 103, the audio output unit 104, the input unit 102, and the secondary storage unit 106 are not always required when external units not shown satisfy the same functions. However, for descriptive purposes, in the following description, it is assumed that the video/audio player according to the first embodiment of the present invention includes those units.

The video/audio data input unit 100 inputs video/audio data. The video/audio data input unit 100 may be, for example, a unit that reads video/audio data stored in the storage unit 105 or the secondary storage unit 106 which will be described later, or a tuner unit of TV when receiving TV broadcasting. The tuner unit includes, for example, a demodulation section that demodulates broadcast signals, and a channel tuning section that tunes channels of the broadcast signals. When the video/audio data is inputted through a network, the video/audio data input unit 100 can be a network card such as a LAN card.

The central processing unit 101 is mainly configured by a microprocessor, and executes a program stored in the storage unit 105 or the secondary storage unit 106.

The input unit 102 is realized by, for example, a remote control unit, a keyboard, or a pointing device such as a mouse. A user designates the video/audio data to be input to the video/audio data input unit 100 by using the input unit 102 to designate the video/audio data to be viewed, and select menu items. Also, the user issues an instruction for skipping a video playback position to a chapter point which will be described later, or issues an instruction for returning the video playback position to a skip start position when automatically skipping the video playback position, by using the input unit 102.

The display unit 103 is realized by, for example, a display adaptor and a liquid crystal panel, or a projector. The display unit 103 displays video included in playback data, a running bar which will be described later, or a menu for giving an instruction to the video/audio player by the user.

The audio output unit 104 is realized by, for example, an audio card and a speaker, and outputs an audio included in the playback video/audio data.

The storage unit 105 is realized by, for example, a random access memory (RAM) and a read only memory (ROM). The storage unit 105 stores program to be executed by the central processing unit 101, data to be processed in the video/audio player, or video/audio data to be reproduced therein.

The secondary storage unit 106 is configured by, for example, a hard disc, a DVD, a CD, or their drives, or a nonvolatile memory such as a flash memory. The secondary storage unit 106 stores a program to be executed by the central processing unit 101, data to be processed in the video/audio player, or video/audio data to be reproduced therein.

Subsequently, functional blocks of the video/audio player according to the first embodiment of the present invention will be described.

FIG. 2 is a functional block diagram of the video/audio player according to the first embodiment of the present invention. Parts or all of those functional blocks may be realized as hardware in addition to the hardware illustrated in FIG. 1, but may be realized as a software program to be realized by the central processing unit 101. In the following description, it is assumed that all of those functional blocks are a software program to be executed by the central processing unit 101.

As illustrated in FIG. 2, the video/audio player according to the first embodiment of the present invention includes a video/audio data input section 201, a chapter point setting section 202, an automatic skip interval setting section 203, a data retention section 204, a playback control section 205, a skip designation section 206, an audio output section 207, and a display section 208. The playback control section 205, the skip designation section 206, the audio output section 207, and the display section 208 are not always required when an external device satisfies the same functions, for example, the external device reproduces the video/audio data. However, for descriptive purposes, in the following description, it is assumed that the video/audio player according to the first embodiment includes those sections.

The video/audio data input section 201 receives, from the video/audio data input unit 100, video/audio data to be subjected to chapter setting and automatic skip interval setting which will be described later, and video/audio data to be reproduced.

The chapter point setting section 202 detects CM intervals included in video/audio data input by the video/audio data input section 201, and allocates chapters to the video/audio data on the basis of the detected CM intervals. In particular, the CM intervals are detected by using a CM interval detecting method that detects the respective CM intervals within the video/audio data “without detection failure” to the utmost extent. Then, chapter data which will be described later is generated with end positions of the respective detected CM intervals as chapter points. The CM interval detecting method and the chapter point setting method in the chapter point setting section 202 will be described in detail later.

The automatic skip interval setting section 203 detects the CM intervals included in the video/audio data which is inputted by the video/audio data input section 201, and sets intervals to be automatically skipped during playback of the video/audio data on the basis of the detected CM intervals. In particular, the CM intervals are detected by using the CM interval detecting method that detects the respective CM intervals within the detected video/audio data “without false detection” to the utmost extent. Then, automatic skip interval data which will be described later is generated with the respective CM intervals as automatic skip intervals. The CM interval detecting method and the automatic skip interval setting method in the automatic skip interval setting section 203 will be described in detail later.

A known technique can be applied to those CM interval detecting methods. According to the first embodiment of the present invention, it is important that the CM intervals are detected “without detection failure” to the utmost extent in the chapter point setting section 202. It is also important that the CM intervals are detected “without false detection” to the utmost extent in the automatic skip interval setting section 203. That is, the CM interval detection high in detection rate is conducted in the chapter point setting section 202, and the CM interval detection high in accuracy rate is conducted in the automatic skip interval setting section 203. The detection rate and the accuracy rate are defined as follows when it is assumed that F is the set of real CM intervals, and R is the detected CM intervals.

Detection rate=|F∩R|/|F|. (1)

Accuracy rate=|F∩R|/|R|. (2)

In the chapter point setting section 202, particularly, it is important that the detection rate of the CM interval end positions is enhanced.

The data retention section 204 retains chapter data generated in the chapter point setting section 202 and automatic skip interval data generated in the automatic skip interval setting section 203. This can be realized by storing, in the storage unit 105 or the secondary storage unit 106, the chapter data generated in the chapter point setting section 202 and automatic skip interval data generated in the automatic skip interval setting section 203.

The display section 208 displays playback video produced by the playback control section 205 which will be described later, and a menu and a running bar which will be described later in the display unit 103.

The audio output section 207 outputs a playback audio produced by the playback control section 205 which will be described later to the audio output unit 104.

The skip designation section 206 instructs the playback control section 205 to skip the presently reproducing video/audio data to a subsequent chapter point through the input unit 102 by the user. This can be realized by determining that skip has been instructed, for example, when a predetermined button of a remote control unit has been depressed by the user.

The playback control section 205 receives the video/audio data from the video/audio data input section 201, generates the playback image and the playback audio, and outputs the playback image to the display section 208 and the playback audio to the audio output section 207 to reproduce the video/audio data. Also, the playback control section 205 obtains the present playback position, acquires a subsequent chapter point, and jumps the playback position to the subsequent chapter point to continue playback on the basis of a positional relationship between the present playback position and the subsequent chapter point according to an instruction from the skip designation section 206. The control contents in the playback control section 205 will be described in detail later.

Subsequently, the processing contents conducted in the chapter point setting section 202 will be described.

The chapter point setting section 202 detects the CM intervals included in the video/audio data which has been input by the video/audio data input section 201, and allocates the chapter points to the video/audio data on the basis of the detected CM intervals. A known technique can be applied to the CM interval detecting method. However, as described above, the CM interval detecting method is a method (high in detection rate) that can detect the respective CM intervals within the video/audio data “without detection failure” to the utmost extent. As the CM interval detecting method, there are known, for example, a method using video and audio within the video/audio data, and a method using only the audio. The CM interval detecting method using only audio is higher in the detection rate than the CM interval detecting method using video and audio. Accordingly, the chapter point setting section 202 according to the first embodiment of the present invention employs the CM interval detecting method using only audio.

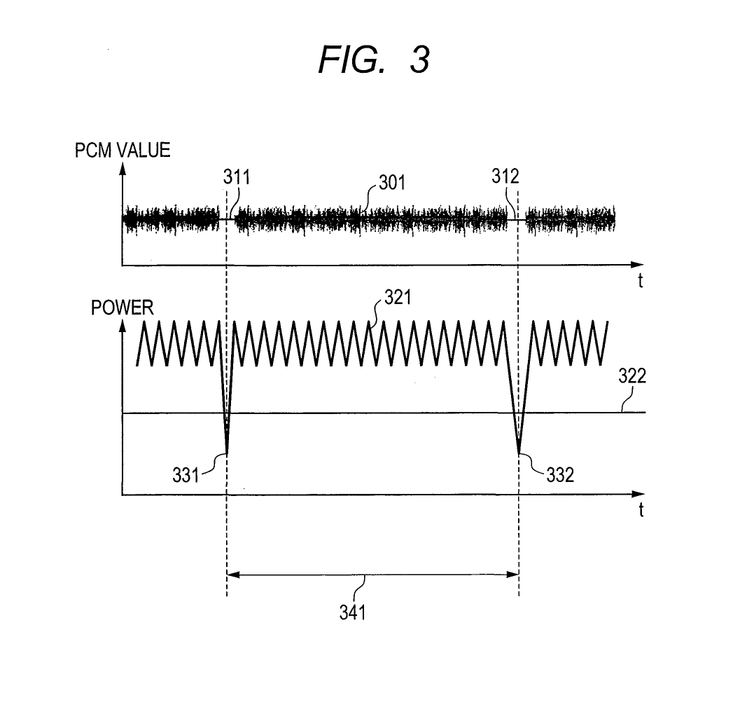

FIG. 3 is an explanatory diagram for describing the outline of a method of detecting CM intervals according to only audio in the video/audio data.

Referring to FIG. 3, reference numeral 301 denotes plotted PCM (pulse code modulation) values of audio data included in the video/audio data, and reference numeral 321 is plotted audio powers of the video/audio data per unit time. Reference numerals 311 and 312 in FIG. 3 represent a silent state. For the silent points, the audio power is compared with a predetermined threshold value 322, and power points (331 and 332) that fall below the threshold value can be detected as the silent points. When an interval length 341 between the silent points is multiples of 15 seconds, the interval is detected as a CM interval.

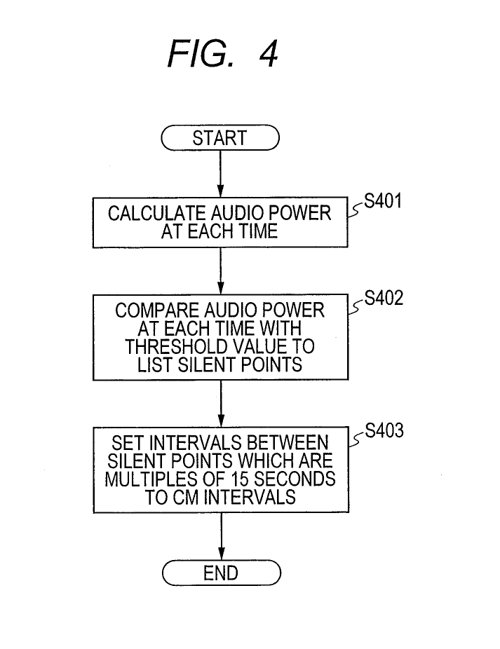

FIG. 4 is a flowchart showing an example of the CM detecting method when the CM intervals are detected according to only audio in the video/audio data.

As shown in FIG. 4, in detection of the CM intervals, the audio power per unit time at each time is calculated (Step S401), and the calculated audio power per unit time at each time is compared with a predetermined threshold value. Then, time positions each having a power lower than the threshold value are listed to list the silent points (Step S402). Then, the intervals in which the interval length of the silent points is multiples of 15 seconds are set as the CM intervals (Step S403).

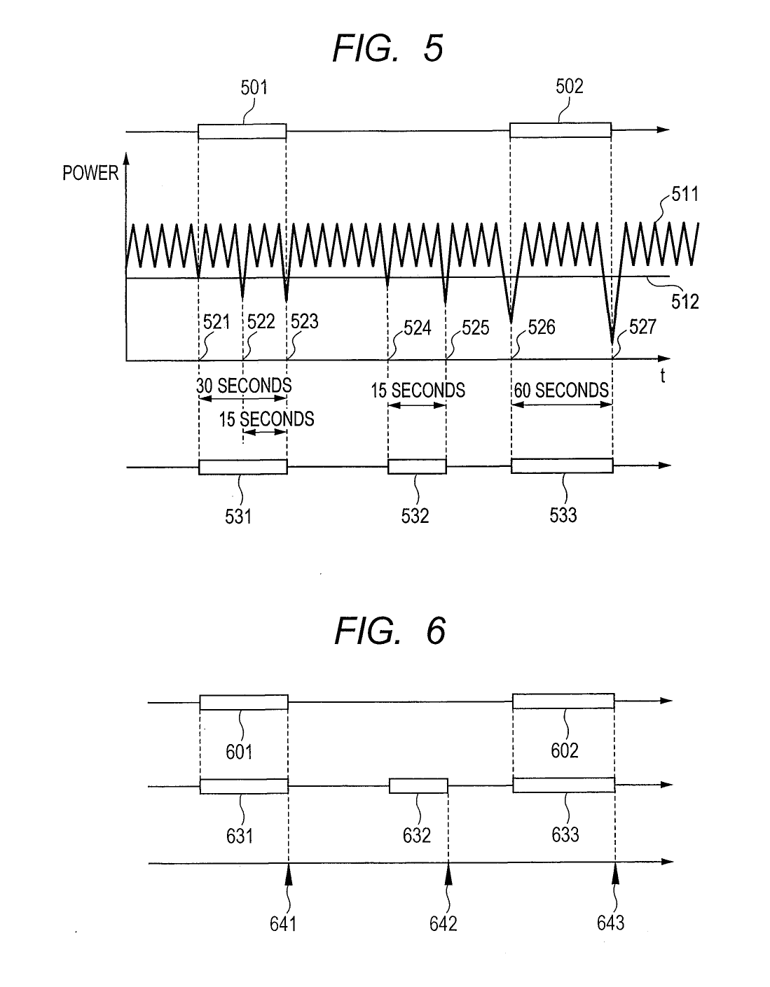

FIG. 5 is a diagram illustrating an example of the CM intervals when the CM intervals are detected according to only audio in the video/audio data.

Referring to FIG. 5, reference numerals 501 and 502 denote actual CM intervals in the video/audio data, and 511 is plotted powers of the audio data per unit time in the video/audio data. When a threshold value for detecting the silent points is represented by reference numeral 512, points 521 to 527 where power fall below the threshold value 512 are detected as the silent points. It is determined whether the intervals between those silent points are multiples of 15 seconds or not, and intervals 531 to 533 which are multiples of 15 seconds are detected as CM intervals.

When the continuous intervals are multiples of 15 seconds, an interval including those intervals is detected as the CM interval. In an example illustrated in FIG. 5, the interval between the silent points 521 and 522 and the interval between the silent points 522 and 523 are each 15 seconds, and the interval 531 that includes those intervals is detected as a CM interval.

Subsequently, a method of setting the chapter points, which is conducted by the chapter point setting section 202 according to the first embodiment of the present invention, will be described.

FIG. 6 is an explanatory diagram for describing a method of setting the chapter points which is conducted by the chapter point setting section 202.

Referring to FIG. 6, reference numerals 601 and 602 indicate actual CM intervals in the video/audio data, which correspond to actual CM intervals 501 and 502 in FIG. 5. Reference numerals 631 to 633 corresponding to the intervals 531 to 533 in FIG. 5 indicate CM intervals detected in the chapter point setting section 202. The chapter point setting section 202 sets end positions 641 to 643 of the detected CM intervals 631 to 633 as chapter points, and generates chapter data that will be described later. The CM intervals 532 and 632 are not actual CM intervals, but false-detected CM intervals, which leads to no problem in the video/audio player according to the present invention as will be described later.

Subsequently, processing contents conducted by the automatic skip interval setting section 203 according to the first embodiment of the present invention will be described.

Like the chapter point setting section 202, the automatic skip interval setting section 203 detects the CM intervals included in the video/audio data which has been input by the video/audio data input section 201, but employs a method different from the CM interval detecting method conducted by the chapter point setting section 202. That is, the automatic skip interval setting section 203 sets the detected CM intervals as the automatic skip intervals by using the CM interval detecting method (high in the accuracy rate) that detects the CM intervals “without false detection” to the utmost extent.

Similarly, the CM interval detecting method which is conducted by the automatic skip interval setting section 203 can employ a publicly known art, but uses a method (high in the accuracy rate) that can detect the respective CM intervals within the video/audio data “without false detection” to the utmost extent as described above. For example, the CM interval detecting method using video and audio is higher in the accuracy rate than the CM interval detecting method that is conducted by the chapter point setting section 202 in the example described above, that is, the detecting method using only audio within the video/audio data. Accordingly, in the following description, it is assumed that the automatic skip interval setting section 203 according to the first embodiment employs the CM interval detecting method using video and audio.

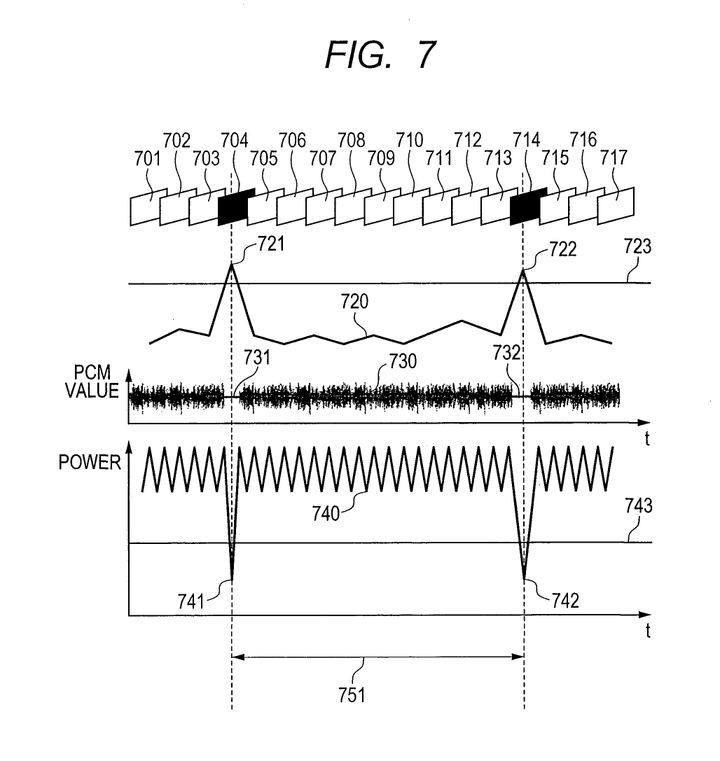

FIG. 7 is an explanatory diagram for describing the outline of the method of detecting the CM intervals according to video and audio in the video/audio data.

Referring to FIG. 7, reference numerals 701 to 717 indicate each video included in the video/audio data (image frames), and reference numerals 704 and 714 particularly indicate images in which scenes change. Reference numeral 720 denotes plotted variations of the respective images to previous images in a histogram. The histogram represents a distribution of brightness of images. Reference numerals 721 and 722 denote points of the scene change images in which the variation in the histogram is higher. The variation of the histogram is compared with a threshold value 723 for detecting the scene change, and points 721 and 722 at which the variations of the histogram are higher than the threshold value 723 are detected as the scene change points.

Reference numeral 730 represents plotted PCM (pulse code modulation) values of the audio data included in the video/audio data. Reference numeral 740 represents plotted powers of the video/audio data per unit time. Referring to FIG. 7, reference numerals 731 and 732 are positions of a silent state. For the silent points, the audio powers are compared with a threshold value 743, and power points (741 and 742) that fall below the threshold value 743 can be detected as the silent points. When an interval length 751 between points at which the silent points and the scene changes occur at the same time are multiples of 15 seconds, the interval is detected as a CM interval.

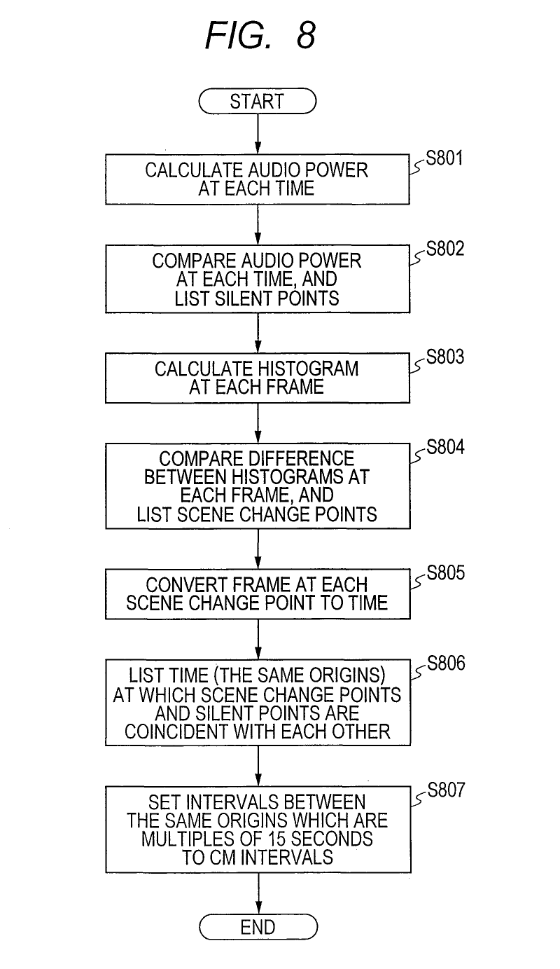

FIG. 8 is a flowchart showing an example of the CM detecting method when the CM intervals are detected according to video and audio in the video/audio data.

As shown in FIG. 8, an audio power per unit time at each time is first calculated (Step S801), and the calculated audio power per unit time at each time is compared with a predetermined threshold value. Time positions each having a power lower than the threshold value are listed to list the silent points (Step S802). Then, the histogram of each image frame is calculated (Step S803), and differences in the histogram between the respective image frames are compared with a predetermined threshold value. Then, image frames each having a histogram difference value larger than the threshold value are listed as the scene change points (Step S804), and positions of the image frames at the respective scene change points are converted to times (Step S805). Then, times (the same origins) at which the scene change points and the silent points are coincident with each other (occur at the same time) are listed (Step S806), and intervals at which the interval lengths having the same origin are multiple of 15 seconds are set as CM intervals (Step S807). The time is based on the playback start time of a first image frame among plural image frames configuring the video/audio data.

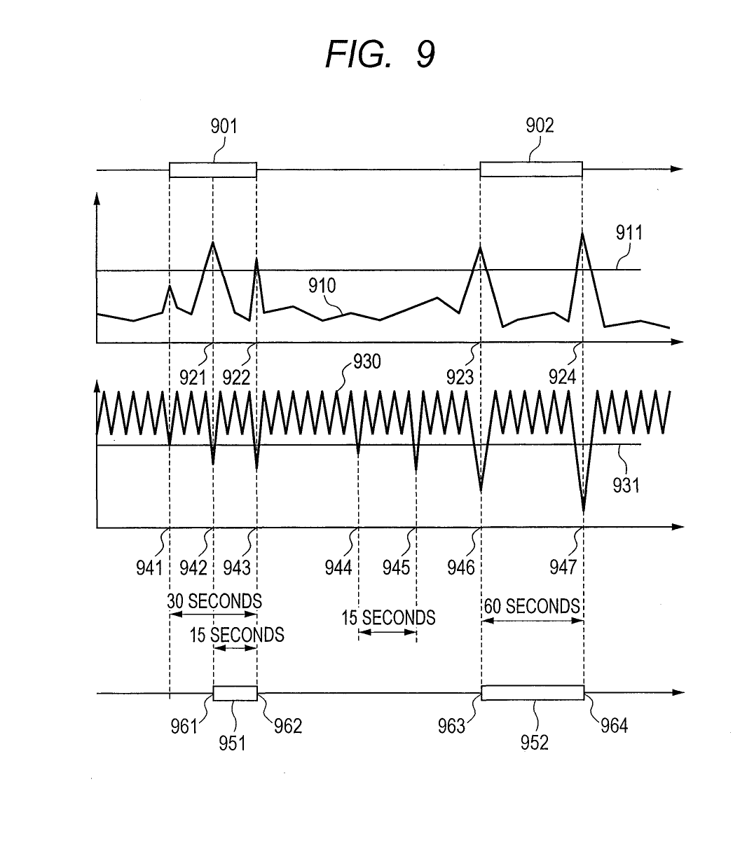

FIG. 9 is a diagram illustrating an example of the CM intervals when the CM intervals are detected according to audio and video in the video/audio data.

Referring to FIG. 9, reference numerals 901 and 902 denote actual CM intervals in the video/audio data, and reference numeral 910 represents plotted variations of the respective images to previous images in a histogram. When it is assumed that a threshold value for detecting the scene changes is represented by reference numeral 911, points 921 to 924 at which the variations of the histogram are higher than the threshold value 911 are listed as the scene change points. Also, referring to FIG. 9, reference numeral 930 denotes plotted powers of the audio data in the video/audio data. In this case, when it is assumed that a threshold value for detecting the silent points is represented by reference numeral 931, points 941 to 947 at which the audio powers per unit time is lower than the threshold value 931 can be detected as the silent points, and times (the same origins) at which the scene change points and the silent points are coincident with each other (occur at the same time) can be detected as reference numerals 961 to 964. Then, it is determined whether the intervals of the same origins are multiples of 15 seconds, or not, to detect the reference numerals 951 and 952 as the CM intervals.

Subsequently, an automatic skip interval setting method which is conducted by the automatic skip interval setting section 203 according to the first embodiment of the present invention will be described.

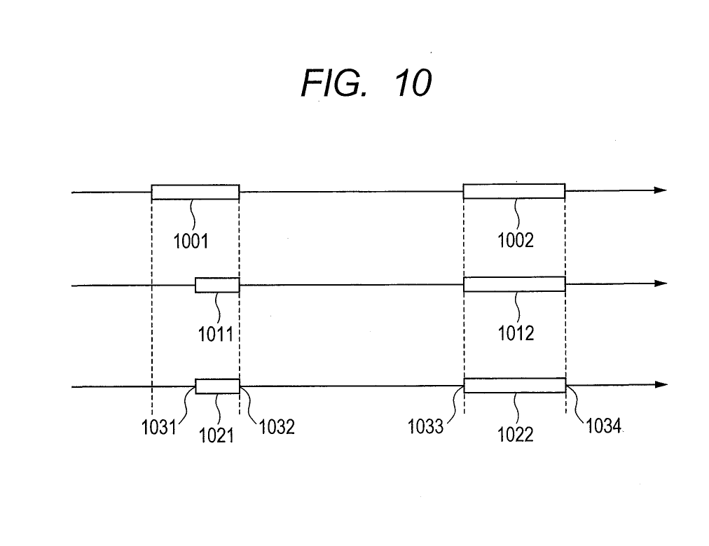

FIG. 10 is an explanatory diagram for describing the automatic skip interval setting method in the automatic skip interval setting section 203 according to the embodiment of the present invention.

Referring to FIG. 10, reference numeral 1001 and 1002 indicate actual CM intervals in the video/audio data, which correspond to the actual CM intervals 901 and 902 in FIG. 9. Also, reference numerals 1011 and 1012 corresponding to the CM intervals 951 and 952 in FIG. 9 indicate CM intervals detected by the automatic skip interval setting section 203. The automatic skip interval setting section 203 generates automatic skip interval data, which will be described later, with sets of start positions and end positions (1031 and 1032, 1033 and 1034) of the detected CM intervals as automatic skip intervals 1021 and 1022. The automatic skip interval 1021 is smaller than an actual CM interval, which is a CM interval with a detection failure, which however leads to no problem in the video/audio player according to the present invention as will be described later.

Subsequently, a data structure of the chapter data according to the embodiment of the present invention will be described.

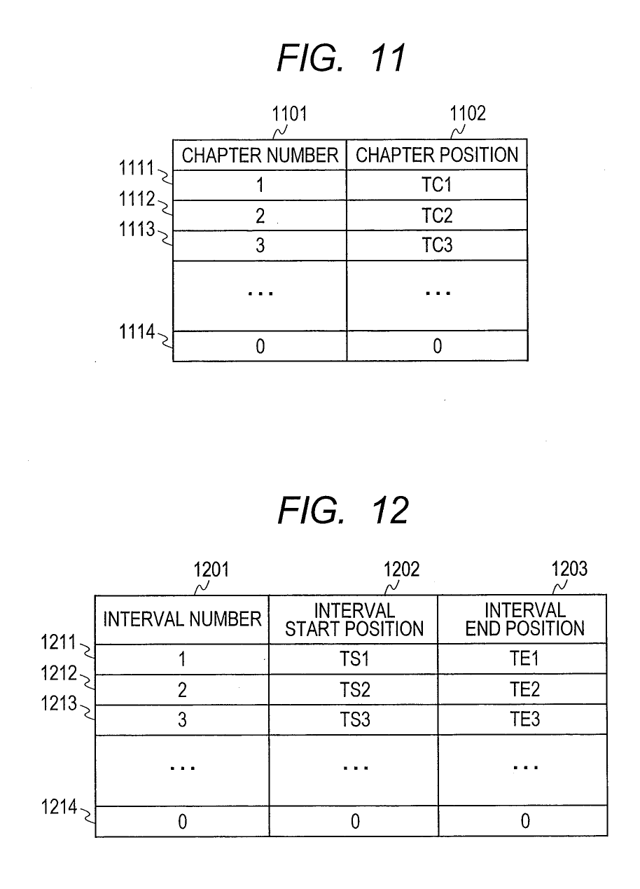

FIG. 11 is a diagram showing an example of the data structure of the chapter data according to the embodiment of the present invention. The chapter data is generated by the chapter point setting section 202 in the first embodiment, and retained in the storage device 105 or the secondary storage device 106. Also, the chapter data is inputted from the storage unit 105 or the secondary storage unit 106 by the playback control section 205, and referred to.

Referring to FIG. 11, numeral reference 1101 denotes a chapter number. Also, reference numeral 1102 denotes chapter position, and may be a time at the end position of the CM interval detected in the chapter point setting section 202 in the first embodiment. Reference numerals 1111 to 1113 each represent one chapter, and indicate that there are three chapters in this example.

As described above, the chapter point setting section 202 allocates the chapter number 1101 to each sequential for each end point of the detected CM intervals within the video/audio data, and stores a time at the end position of each CM interval as the chapter position 1102 to generate the chapter data. The generated chapter data is retained in the storage unit 105 or the secondary storage unit 106 by the data retention section 204.

The playback control section 205 acquires the chapter data from the storage unit 105 or the secondary storage unit 106 through the data retention section 204, and acquires, from the chapter data, the chapter position temporally after and temporally closest to a present playback position among the present playback position in the playback video/audio data. The acquired chapter position becomes a subsequent chapter position. In the present description, the chapter position is defined as “time within the video/audio data”, but is not limited to this. For example, the chapter position may be a position within the video/audio data such as “a video frame number within the video/audio data”.

Referring to FIG. 11, reference numeral 1114 denotes an end of the chapter data. In the end 1114 of the chapter data, the chapter point setting section 202 stores 0 in each of the chapter number 1101 and the chapter position 1102. The playback control section 205 can recognize the end of the chapter data by confirming that both of the chapter number 1101 and the chapter position 1102 are 0 in position.

Subsequently, a data structure of the automatic skip interval data according to the embodiment of the present invention will be described.

FIG. 12 is a diagram showing an example of the data structure of the automatic skip interval data according to the embodiment of the present invention.

The automatic skip interval data is generated by the automatic skip interval setting section 203, and retained in the storage unit 105 or the secondary storage unit 106 in the first embodiment. The automatic skip interval data is inputted from the storage unit 105 or the secondary storage unit 106 by the playback control section 205, and referred to.

Referring to FIG. 12, reference numeral 1201 denotes an interval number of the automatic skip interval. Also, reference numeral 1202 denotes an interval start position of the automatic skip interval indicated by reference numeral 1201, and 1203 is an interval end position of the automatic skip interval indicated by reference numeral 1201. Those positions may be a time at the start position and a time at the end position in the CM interval detected by the automatic skip interval setting section 203 in the first embodiment. Reference numerals 1211 to 1213 each represent one automatic skip interval, and indicate that there are three automatic skip intervals in this example.

As described above, the automatic skip interval setting section 203 allocates the interval number 1201 to the sequential for each of the detected CM intervals, and stores times at the start position and the end position of each CM interval within the video/audio data as the interval start position 1202 and the interval end position 1203, respectively, to generate the automatic skip interval data. The generated automatic skip interval data is retained in the storage unit 105 or the secondary storage unit 106 by the data retention section 204.

The playback control section 205 acquires the automatic skip interval data from the storage unit 105 or the secondary storage unit 106 through the data retention section 204. Then, the playback control section 205 skips the present playback position to the interval end position of the automatic skip interval when the present playback position in the playback video/audio data is located temporally after the interval start position of the automatic skip playback interval. Then, the playback control section 205 conducts the normal playback after that interval end position. In this description, both of the start position and the end position of the automatic skip interval are defined as “times within the video/audio data”, but are not limited to those times. Both or one of the start position and the end position may be, for example, “video frame number within the video/audio data”. That is, the start position and the end position of the automatic skip interval may be anyone that is indicative of the position within the video/audio data.

Referring to FIG. 12, reference numeral 1214 indicates the end of the automatic skip interval data. In the end of interval data, the automatic skip interval setting section 203 stores 0 in the interval number 1201, and stores 0 in each of the interval start position 1202 and the interval end position 1203. The playback control section 205 can recognize the end of the automatic skip interval data by confirming that each of the interval number 1201, the interval start position 1202, and the interval end position 1203 is 0 in position.

Subsequently, the processing contents conducted by the playback control section 205 of the video/audio player according to the embodiment of the present invention will be described.

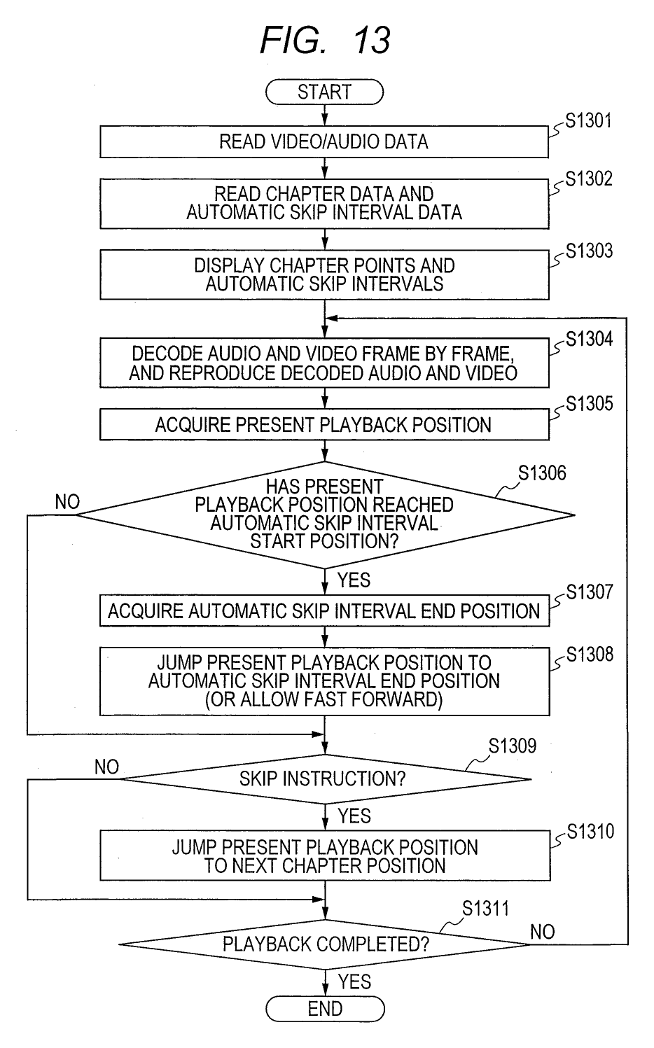

FIG. 13 is a flowchart showing an example of the processing contents conducted by the playback control section 205.

The playback control section 205 starts the operation when video to be reproduced is selected by the user. As shown in FIG. 13, when the playback control section 205 starts the operation, the playback control section 205 first reads video/audio data to be reproduced (Step S1301), and reads the chapter data and the automatic skip interval data in the video/audio data (Step S1302). The data retention section 204 retains the chapter data and the automatic skip interval data in the storage unit 105 or the secondary storage unit 106 with a file name associated with the video/audio data to be generated. As a result, the playback control section 205 can read the chapter data and the automatic skip interval data of the file name associated with the video/audio data to be reproduced which has been read in Step S1301.

Subsequently, the playback control section 205 displays the chapter points obtained from the chapter data and the automatic skip interval obtained from the automatic skip interval data on the display section 208 (Step S1303). A screen example to be displayed will be described later.

Then, the playback control section 205 decodes video and audio included in the video/audio data frame by frame, and reproduces the video and the audio (Step S1304). In this situation, the playback control section 205 acquires the present playback position (Step S1305), and confirms whether the acquired present playback position has reached the start position of the automatic skip interval in the automatic skip interval data, or not (Step S1306). When it is determined that the presently producing position has reached the start position of the automatic skip interval in the automatic skip interval data, the playback control section 205 acquires the end position of the automatic skip interval from the automatic skip interval data (Step S1307), and jumps the playback position to the acquired automatic skip interval end position (Step S1308) to continue the playback of the video/audio data.

On the other hand, as result of the determination in the above Step S1306, when the presently producing position have not reached the start position of the automatic skip interval in the automatic skip interval data, the playback control section 205 continues the playback of the video/audio data without skipping the playback position. When the playback control section 205 skips the playback position in the above Step S1308, the playback control section 205 may reproduce the video/audio data included in the interval to be skipped with fast forward.

The playback control section 205 also determines whether a skip instruction has been conducted from the user during the playback of the video/audio data, or not (Step S1309). When the skip instruction has been made, the playback control section 205 jumps the playback position to a subsequent chapter position (Step S1310) to continue the playback of the video/audio data.

Whether the skip instruction has been conducted, or not, can be determined by determining whether the skip instruction has been conducted from the user through the input unit 102 and the skip designation section 206, or not. This may be determined by determining whether the user has operated a predetermined button of a remote control unit or the like, or not, or whether a predetermined operation has been conducted by a mouse or the like, or not. Also, when the playback control section 205 jumps the playback position to a subsequent chapter position, the playback control section 205 acquires the chapter position temporally after and temporally closest to a present playback position acquired at Step S1305, from the chapter data to acquire the subsequent chapter position, and jumps the playback position to the subsequent chapter position to thereby realize jumping of the playback position to the subsequent chapter position.

On the other hand, as a result of the determination in the above Step S1309, when it is determined that no skip instruction is conducted from the user, the playback control section 205 continues playback of the video/audio data without skipping the playback position.

The playback control section 205 then determines whether playback has been completed up to the end point of the video/audio data, or not (Step S1311). When playback has not been completed up to the end point of the video/audio data, the processing of Steps S1304 to S1311 is repeated so that playback is completed up to the end point of the video/audio data, and continuously reproduces video and audio included in the video/audio data.

On the other hand, as a result of the determination in Step S1311, when it is determined that playback has been completed up to the end point of the video/audio data, the playback control section 205 completes the processing.

Subsequently, a display screen example of the video/audio player according to the embodiment of the present invention will be described.

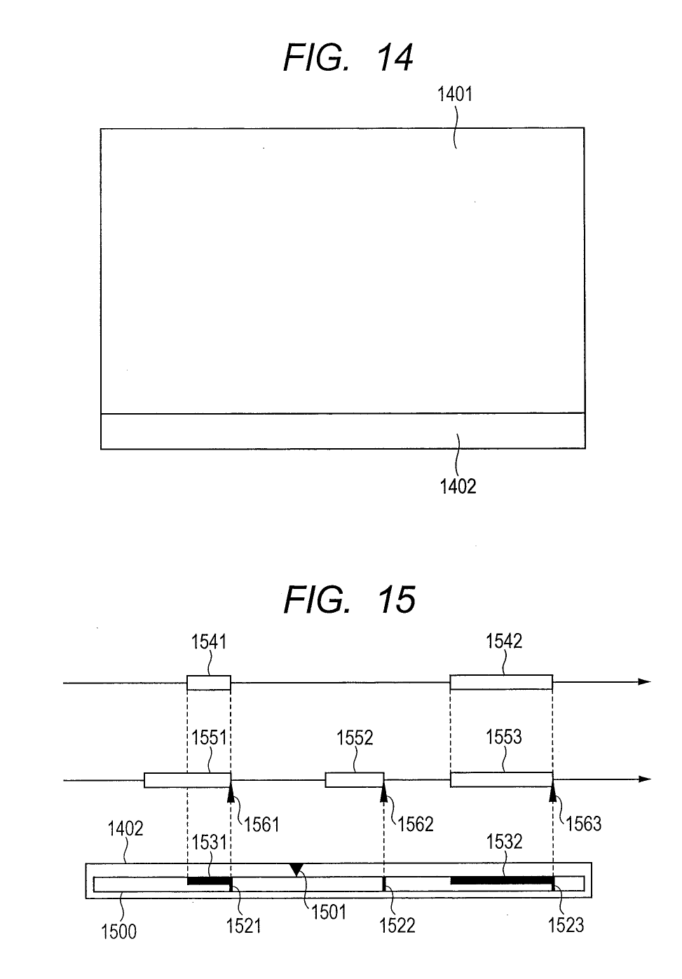

FIG. 14 is a diagram illustrating an example of the display screen configuration of the video/audio player according to the embodiment of the present invention.

Referring to FIG. 14, reference numeral 1401 denotes a video display area in which a playback image of the video/audio data is displayed. Also, reference numeral 1402 denotes a running bar display area in which the present playback position, the chapter position, and the automatic skip interval are displayed.

FIG. 15 is a diagram illustrating a display example of the running bar in the display screen configuration of the video/audio player according to the embodiment of the present invention.

In FIG. 15, for description, the CM intervals detected by the automatic skip interval setting section 203 and set as the automatic skip intervals are indicated as reference numerals 1541 and 1542. The CM intervals detected by the chapter point setting section 202 are indicated as reference numerals from 1551 to 1553. Also, the chapter points set by the chapter point setting section 202 are indicated as reference numerals from 1561 to 1563.

As illustrated in FIG. 15, in the video/audio player according to the embodiment of the present invention, a running bar 1500 and a present playback position 1501 are displayed in a running bar display area 1402. Also, intervals that correspond to the automatic skip intervals 1541 and 1542 and are automatically skipped are displayed by rectangles indicated by reference numerals 1531 and 1532. Further, positions corresponding to the chapter points 1561 to 1563 set by the chapter point setting section 202 are displayed by markers indicated by reference numerals from 1521 to 1523.

In FIG. 15, for descriptive purposes, an example in which a length of the running bar and a length of the content are displayed at 1:1 is shown. Therefore, the interval lengths and positions of the automatic skip intervals, and the positions of the chapters are displayed at the same positions or sizes. However, in the actual display, it is preferred that when it is assumed that the length of the running bar is a length of the video content to be reproduced, the rates of the positions and sizes of the respective display are calculated, and display is made according to the rates.

Subsequently, a user interface of the video/audio player according to the embodiment of the present invention will be described.

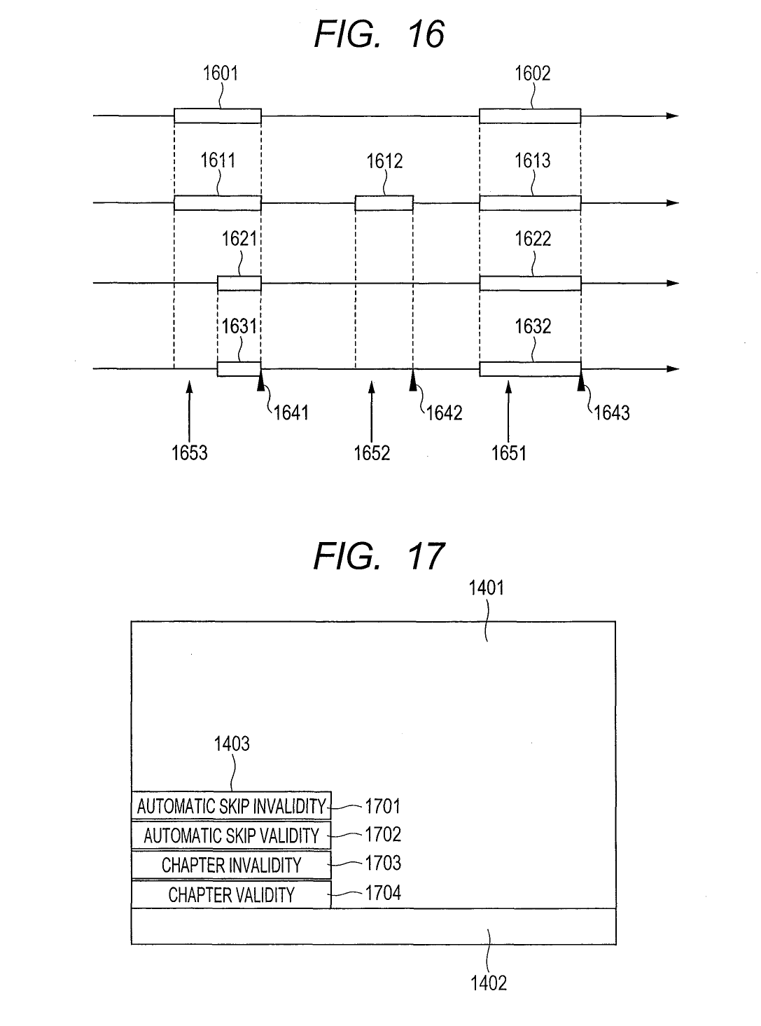

FIG. 16 is an explanatory diagram for describing the user interface of the video/audio player according to the embodiment of the present invention.

In FIG. 16, reference numerals 1601 and 1602 indicate actual CM intervals, and reference numerals from 1611 to 1613 indicate the CM intervals detected by the chapter point setting section 202. Also, reference numerals 1621 and 1622 indicate the CM intervals detected by the automatic skip interval setting section 203. Reference numerals 1631 and 1632, and from 1641 to 1643 are the respective automatic skip intervals set by the automatic skip interval setting section 203, and the chapter points set by the chapter point setting section 202.

According to the video/audio player of the present invention, for example, when the playback position in the video/audio data is within the CM interval indicated by reference numeral 1651 shown in FIG. 16, and the CM interval is set as the automatic skip interval, the CM interval is automatically skipped without any user's action. Also, a playback position in the video/audio data as indicated by reference numeral 1652 shown in FIG. 16 is not set in the automatic skip interval although the playback position is within the CM interval 1612 that has been erroneously detected by the chapter point setting section 202. Therefore, the interval is not automatically skipped. Further, a playback position in the video/audio data as indicated by reference numeral 1653 shown in FIG. 16 is in the CM interval that has not been detected by the automatic skip interval setting section 203 although the playback position is actually in the CM interval. In this case, although the CM interval is not automatically skipped, the playback position is skipped to the chapter point 1641 by conducting a skip instruction by the user, thereby surely enabling skip of the CM interval.

In the video/audio player according to the embodiment of the present invention, the validity/invalidity of the chapter point set by the chapter point setting section 202, and the validity/invalidity of the automatic skip interval set by the automatic skip interval setting section 203 may be designated by the user. In this case, for example, as illustrated in FIG. 17, a menu display area 1403 is disposed in the display screen. Within the menu display area 1403 are displayed menu items 1702 and 1701 that enable the validity/invalidity of the automatic skip to be designated, and menu items 1704 and 1703 that enable the validity/invalidity of the chapters to be designated. With this configuration, the user can select those items through the input unit 102. The user selects the validity/invalidity of the automatic skip or the validity/invalidity of the chapters by operating a given button of the remote control unit, or an up/down button.

Also, when an item of automatic skip invalidity is selected by the user, the automatic skip intervals (for example, automatic skip intervals 1531 and 1532 in FIG. 15) are not displayed in the running bar, and the playback control section 205 does not conduct automatic skip (for example, does not execute Steps S1306 to S1308 in FIG. 13). Also, when an item of chapter point invalidity is selected, the markers of the chapter points (for example, markers 1521 to 1523 in FIG. 15) are not displayed. The playback control section 205 does not jump the playback position to the chapter points (does not execute Steps S1309 and S1310 in FIG. 13), or jumps the playback position to a first playback position or a last position in the video/audio data.

FIG. 17 shows an example in which the validity/invalidity of the automatic skip and the validity/invalidity of the chapters can be set by the user. Alternatively, the validity/invalidity of any one of that automatic skip and the chapters may be set by the user.

Further, in the video/audio player according to the embodiment of the present invention, when the automatic skip interval is automatically skipped, the playback position may be returned to a position before automatic skip to conduct the normal playback by operation using the input unit 102 by the user. This can be realized by, for example, a configuration in which a “back” button is provided in the remote control unit, a start position of the automatic skip interval is acquired when the button is depressed, the playback position is jumped to the automatic skip start position, and the processing of the playback control section 205 is so corrected as to conduct the normal playback.

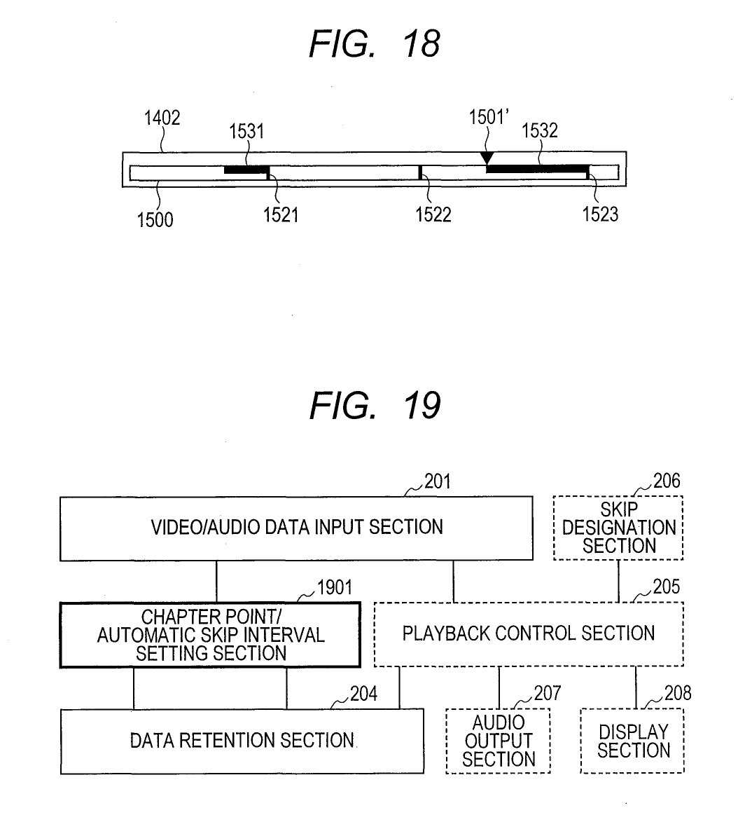

FIG. 18 is a diagram for describing control by which the “back” button of the remote control unit is depressed, and the playback position is returned to the start position of the automatic skip. Referring to FIG. 18, for example, in the case where the interval 1532 set as the automatic skip interval is automatically skipped although the interval 1532 is not an actual CM interval, when the user depresses the “back” button of the remote control unit, the playback position is returned to a position 1501′ before the automatic skip to conduct the normal playback. As a result, the user cancels the skip of the false automatic skip, and can view the continuation of video before skip.

The running bar and the menus may be displayed for a given period of time when the playback of the video/audio data starts, or may be displayed when the user conducts given operation on the input unit 102 (for example, when the user depresses a given button of the remote control unit). As a result, the user can easily confirm the playback position, the automatic skip interval, and the chapter position, and can easily designate the validity/invalidity of the automatic skip, and the validity/invalidity of the chapters.

The video/audio player according to the first embodiment includes the video/audio data input section 201 that inputs the video/audio data, the playback control section 205 that controls the playback of the input video/audio data, the chapter point setting section 202 that detects the end point of the given interval (CM interval) of the input video/audio data, and sets the chapter point to the detected end point, and the automatic skip interval setting section 203 that detects the given interval (CM interval) of the input video/audio data as an interval to be automatically skipped. The playback control section 205 automatically skips the given interval set by the automatic skip interval setting section 203 when the input video/audio data is reproduced, and also upon receiving a skip instruction from the user, skips to a chapter point temporally after and closest to the reproducing playback position among the chapter points set by the chapter point setting section 202. As a result, the given intervals can be automatically skipped to the utmost extent, and even if there is a detection failure of the given intervals, the user can surely skip the given intervals by simple operation.

In particular, according to the video/audio player of the first embodiment, the chapter point setting section 202 detects the end position of the given interval with the use of a method higher in detection rate than the method of detecting the given interval through the automatic skip interval setting section 203. Also, the automatic skip interval setting section 203 detects the given interval with the use of a method higher in accuracy rate than the method of detecting the end position of the given interval through the chapter point setting section 202. As a result, the interval not to be originally skipped is prevented from being automatically skipped, and when a skip instruction is issued by the user, the given interval can be surely skipped.

### Second Embodiment

Subsequently, a video/audio player according to a second embodiment of the present invention will be described with reference to the drawings.

FIG. 19 is a functional block diagram of the video/audio player according to the second embodiment of the present invention. In the following description, like the first embodiment, it is assumed that all of those functional blocks are a software program to be executed by the central processing unit 101.

As illustrated in FIG. 19, the video/audio player according to the second embodiment of the present invention does not include the chapter point setting section 202 and the automatic skip interval setting section 203 in the video/audio player of the first embodiment, separately, but includes one “chapter point/automatic skip interval setting section” 1901. As will be described later, the chapter point/automatic skip interval setting section 1901 generates the chapter data and the automatic skip interval data with the use of one CM interval detecting method. The other configurations, data structure, processing contents, display screen, and user interface can be made identical with those in the first embodiment of the present invention, and therefore their description will be omitted. As described above, the playback control section 205, the skip designation section 206, the audio output section 207, and the display section 208 are not always required when the same functions are satisfied by an external device, for example, playback is conducted by the external device. Therefore, those components are indicated by dotted lines in FIG. 19. Hereinafter, the processing contents to be conducted by the chapter point/automatic skip interval setting section 1901 will be described.

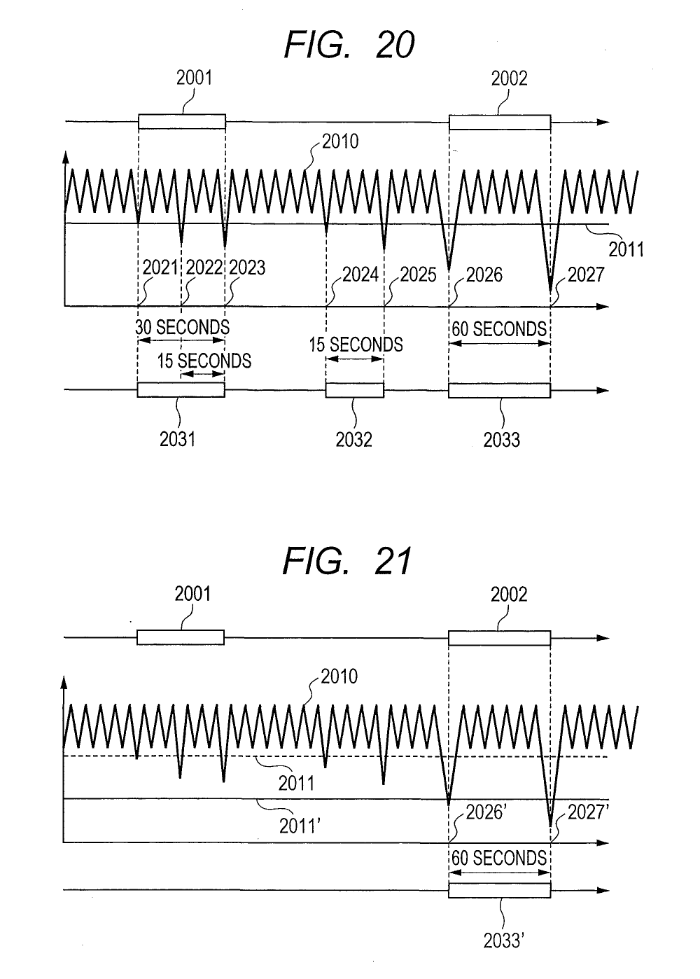

FIG. 20 is an explanatory diagram illustrating an example of the CM interval detecting method used in the chapter point/automatic skip interval setting section 1901 of the video/audio player according to the second embodiment of the present invention. In particular, FIG. 20 is an explanatory diagram for describing an example of a parameter setting method for detecting the CM intervals in order to set the chapter point in the method for detecting the CM intervals with use of only the above-mentioned audio data.

Referring to FIG. 20, reference numerals 2001 and 2002 indicate actual CM intervals in the video/audio data, and reference numeral 2010 is plotted powers of the audio data per unit time in the video/audio data. In this case, when it is assumed that a threshold value for detecting silent points is indicated by reference numeral 2011, silent points 2021 to 2027 lower in an audio power per unit time than the threshold value 2011 are detected. It is determined whether the intervals between those silent points are multiples of 15 seconds, or not, and the silent points 2031 to 2033 which are multiples of 15 seconds are detected as the CM intervals. The chapter point/automatic skip interval setting section 1901 generates the chapter data with the end positions of the CM intervals thus detected as the chapter points.

On the other hand, the chapter point/automatic skip interval setting section 1901 detects the CM intervals with the use of different parameter sets in the same method as the CM interval detection for setting the chapter points, that is, in the method of detecting the CM intervals with the use of only the audio data, for example. Then, the chapter point/automatic skip interval setting section 1901 sets the automatic skip intervals.

FIG. 21 is an explanatory diagram illustrating an example of the CM interval detecting method used in the chapter point/automatic skip interval setting section 1901. In particular, FIG. 21 is an explanatory diagram for describing an example of the parameter setting method for detecting the CM intervals in order to set the automatic skip intervals.

In FIG. 21, the actual CM intervals in the video/audio data and the plotted powers of the audio data per unit time in the video/audio data are identical with those in FIG. 20, and are therefore indicated by the same reference numeral. However, a threshold value 2011′ for detecting the silent points is set to be lower than the threshold value 2011 set at the time of generating the chapter data.

The chapter point/automatic skip interval setting section 1901 detects silent points 2026′ to 2027′ lower in the audio power per unit time than the threshold value 2011′. The chapter point/automatic skip interval setting section 1901 determines whether the intervals between those silent points are multiples of 15 seconds, or not, and detects a CM interval 2033′ which is multiples of 15 seconds. As a result, the chapter point/automatic skip interval setting section 1901 can detect the CM interval without false detection of the CM intervals which occurs when the chapter data is generated (without false detection of the interval 2032 shown in FIG. 20 as the CM interval). The chapter point/automatic skip interval setting section 1901 generates the automatic skip interval data with the CM interval thus detected as the automatic skip interval.

Also, the chapter point/automatic skip interval setting section 1901 can detect the CM interval with the use of another parameter set in a method of detecting the CM interval by using only the audio data in the same manner, and set the automatic skip interval.

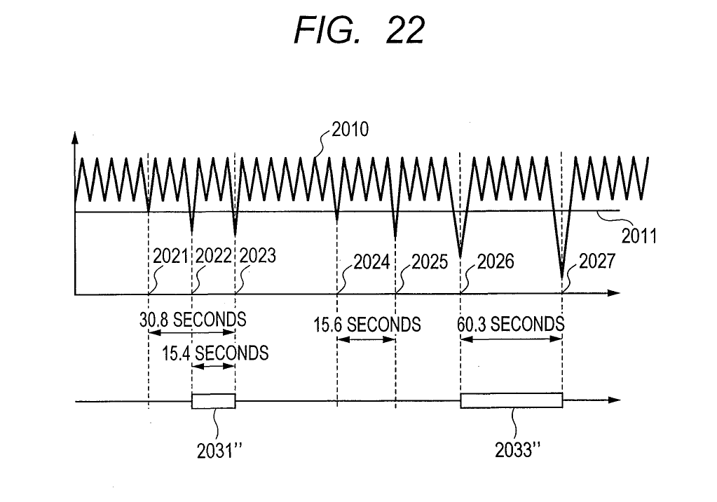

FIG. 22 is an explanatory diagram illustrating another example of the CM interval detecting method used in the chapter point/automatic skip interval setting section 1901. In particular, FIG. 22 is an explanatory diagram for describing another example of a parameter setting method for detecting the CM interval in order to set the automatic skip interval in the method for detecting the CM interval with the use of only the above-mentioned audio data.

Similarly, in FIG. 22, the actual. CM interval in the video/audio data and the plotted powers of the audio data per unit time in the video/audio data are identical with those in FIGS. 20 and 21, and are therefore indicated by the same reference numeral. Also, in FIG. 22, a threshold value for detecting the silent points is set to the same value as the threshold value used at the time of generating the chapter data, and indicated by the same reference numeral (2011) as that in FIG. 20.

Accordingly, as with the time of generating the chapter data, the silent points 2021 to 2027 are detected, and basically it is determined whether the intervals between those silent points are multiples of 15 seconds, or not, to detect the CM intervals. However, in fact, because the intervals between those silent points are not always precisely multiples of 15 seconds, an allowable error from the multiples of 15 seconds is set as a parameter, to thereby detect the CM intervals “without false detection”. For example, when the allowable error from the multiples of 15 seconds is set to ±0.5 seconds, intervals that exceed ±0.5 seconds of multiples of 15 seconds can be excluded from the automatic skip CM intervals. In an example illustrated in FIG. 22, intervals 2031″ and 2033″ that are within ±0.5 seconds of 15 seconds are detected as the CM intervals. As a result, the CM intervals can be detected without false detection of the CM intervals which occurs at the time of generating the chapter data (without false detection of the interval 2032 shown in FIG. 20 as the CM interval). The chapter point/automatic skip interval setting section 1901 generates the automatic skip interval data with the CM interval thus detected as the automatic skip interval.

When the CM intervals are detected with the use of different parameter sets, the parameter sets are not limited to the above-mentioned sets, but may be any parameters that can detect the CM intervals “without detection failure” and any parameters that can detect the CM intervals “without false detection”. Also, the combination of those parameter sets may realize the CM interval detection “without detection failure” and the CM interval detection “without false detection”.

Similarly, for example, in the CM interval detection using video and audio, the threshold value for detecting the scene change points in the histogram difference value, the threshold value for detecting the silent points, or the allowable time difference for determining whether the scene change point and the silent point occur at the same time, or not, can be set to the parameter. Also, in the method using the caption for detection of the CM interval, an interval in which no caption generally appears is detected as the CM interval. Alternatively, the CM interval detection “without detection failure” and the CM interval detection “without false detection” may be realized with an interval length where no caption appears as the parameter.

As described above, the video/audio player according to the second embodiment determines the chapter point by detecting the CM interval without detection failure with the use of the different parameter sets in one CM interval detection method, and also determines the automatic skip interval by detecting the CM interval without false detection. As a result, as in the video/audio player according to the first embodiment, without configuration in which the chapter point setting section and the automatic interval setting section are provided, separately, CM intervals can be automatically skipped to the utmost extent. Also, even when CM intervals that are not automatically skipped exists, CM scenes can be surely skipped by the user's operation.

In the first and second embodiments of the present invention, a case in which the CM intervals are detected to skip CM scenes has been described. However, the skip intervals are not limited to the CM intervals. In the case where scenes that may be low in the important degree, such as scenes which are intended to be skipped or may be skipped by the user are generally skipped, the CM intervals are replaced by the scenes low in the important degree with the results that the skip of such scenes can be realized in the same concept. The scenes that may be low in the important degree are, for example, scenes small in the cheer of audiences or the voice of a commentator in a sport relay.

For example, when the intervals low in the audio power are skipped as the scene intervals low in the important degree, with the threshold value of the audio power for determining that the important degree is low as a parameter, the scene intervals low in the important degree are detected, the chapter data can be generated in the method capable of detecting the scene interval “without detection failure” or by the parameter sets, and the automatic skip interval data can be generated by the method capable of detecting the scene interval “without false detection” or by the parameter sets.

The respective embodiments of the present invention have been described above in detail with reference to the accompanying drawing. However, the specific configurations are not limited to those embodiments, and can include any designs without departing from the subject matter of the present invention.

What is claimed is:

1. A video/audio player, comprising:
a video/audio data input section that inputs video/audio data;
a playback control section that controls playback of the input video/audio data;
a chapter point setting section that detects an end point of a given interval of the input video/audio data, and sets a chapter point to the detected end point; and
an automatic skip interval setting section that detects the given interval of the input video/audio data as an interval to be automatically skipped,
wherein the playback control section automatically skips the given interval set by the automatic skip interval setting section at the time of reproducing the input video/audio data, and upon receiving a skip instruction from a user, skips a reproducing playback position to a chapter point temporally after and closest to the reproducing playback position among the chapter points set by the chapter point setting points.

2. The video/audio player according to claim 1, wherein the chapter point setting section detects the end point of the given interval by using a method higher in detection rate than a method of detecting the given interval by the automatic skip interval setting section.

3. The video/audio player according to claim 1, wherein the chapter point setting section detects the given interval by using a method higher in accuracy rate than a method of detecting the end point of the given interval by the chapter point setting section.

4. The video/audio player according to claim 1, further comprising a setting section that sets at least one of whether the chapter point set by the chapter point setting section is valid or not, and whether the given interval detected by the automatic skip interval setting section is valid or not,
wherein the playback control section implements skip control that is set to be valid by the setting section.

5. The video/audio player according to claim 1, further comprising an automatic skip cancel instruction section that gives instructions to cancel the automatic skip,
wherein the playback control section returns the playback position of the video/audio data to a position before automatic skip to conduct playback when receiving the instructions to cancel the automatic skip from the automatic skip cancel instruction section after conducting control to automatically skip the given interval set by the automatic skip interval setting section.

6. The video/audio player according to claim 1, wherein the chapter point setting section detects the end point of the given interval by using a parameter high in detection rate of the given interval in the same method as the method of detecting the given interval by the automatic skip interval setting section.

7. The video/audio player according to claim 1, wherein the automatic skip interval setting section detects the given interval by using a parameter high in accuracy rate of the given interval in the same method as the method of detecting the end point of the given interval by the chapter point setting section.

8. The video/audio player according to claim 1, wherein the given intervals are commercial message scenes.
